(19) United States
(12) Patent Application Publication
(10) Pub. No.: US 2009/0309414 A1
(43) Pub. Date: Dec. 17, 2009

(54) HILLHOLD BRAKING FUNCTION HAVING INTEGRATED SLIDING TEST

(76) Inventors: Toni Braeuer, Suzhou/Industrial Park (DE); Andreas Streit, Schwieberdingen (DE)

Correspondence Address: KENYON & KENYON LLP, ONE BROADWAY, NEW YORK, NY, 10004, US

(21) Appl. No.: 12/300,665

(22) PCT Filed: Apr. 3, 2007
(86) PCT No.: PCT/EP2007/053217

§ 371 Date: Jun. 25, 2009

(30) Foreign Application Priority Data
May 24, 2006 (DE) 102006024362.5

(51) Int. Cl. B60T 8/32; B60T 7/12

(52) U.S. Cl. 303/191

(57) ABSTRACT

A method for securing a stationary vehicle against unintended rolling, in which the braking pressure occurring in a braking operation is automatically locked in at a plurality of wheel brakes in order to keep the vehicle at standstill, and in which a sliding test is implemented in addition in order to detect sliding of the vehicle. The running time of a pump for reducing the braking pressure at the wheel brake of a test wheel may be shortened considerably if the generation of braking pressure at the wheel brake of the remaining wheel is restricted or completely prevented since less or no brake fluid has to be pumped out in this case.

### FIELD OF THE INVENTION

The present invention relates to a method and a control device for securing a stationary vehicle against unintentional rolling.

### BACKGROUND INFORMATION

These days, vehicles often already come equipped with an automatic braking function, which secures a vehicle standing on an inclined roadway and braked to standstill against renewed rolling. Such braking functions are generally also referred to as hillhold function (HHC) and described in German Patent Application No. DE 199 50 034 A1, for example.

Hillhold functions typically operate in the following manner: In a braking operation in which the driver decelerates the vehicle down to standstill, the braking pressure prevailing at the wheel brakes is blocked with the aid of control valves. To this end, the valves are triggered appropriately by a control device in which the HHC function is stored. This automatically maintains the braking pressure even if the driver takes his foot off the brake pedal. To disengage the brakes again, the driver is usually forced to actuate the driving pedal or to deactivate the HHC function in some other manner, for example with the aid of a release switch.

In most driving situations the conventional hillhold function offers a marked improvement in driving comfort, but it also has some inherent risks under certain circumstances. If the road surface is slippery and icy, a vehicle may begin to slide when started from standstill. A typical situation is an icy entrance ramp of an underground parking facility, for instance, on which the vehicle begins to slide. In such a situation, an inexperienced driver finds it virtually impossible to release the hillhold function quickly enough and thereby bring the vehicle into a steerable state again. In particular, the driver most likely will not actuate the driving pedal in order to release the brake, as should actually be the case.

To avoid such critical situations, conventional HHC systems carry out a sliding test by which the sliding of the vehicle is able to be detected. In the process, the braking pressure locked in at the wheel brakes is reduced at at least one wheel (test wheel), so that the wheel is able to rotate in case the vehicle is sliding. If the rotation of the test wheel exceeds a specified threshold value, then the state “vehicle is sliding” is detected and the hillhold function deactivated automatically, i.e., the braking pressure at the other wheel brakes is reduced as well. This sliding test generally works with sufficient reliability but has the disadvantage of normally requiring a hydraulic pump to reduce the braking pressure at the test wheel. In a vehicle standstill, the running noise of the hydraulic pump may be perceived as annoying by the driver. In addition, the relatively long operating time of the pump causes corresponding wear of the pumps.

### SUMMARY

It is an object of the present invention to realize a hillhold function with a sliding test, in which the operating time of the pump is considerably shorter or in which the pump need no longer be activated at all.

According to one aspect of an example embodiment of the present invention, the rise in the braking pressure is limited during the braking operation at at least one wheel brake or is suppressed completely, so that the braking pressure at this wheel (test wheel) rises only slightly if at all. This makes it possible to considerably shorten the operating time of the pump for the pressure reduction at the test wheel, or to dispense with the use of the pump entirely. This in turn results in less noise and reduced wear of the pump.

In order to limit the pressure increase at the test wheel, a pressure-limiting device such as a valve is preferably triggered appropriately, i.e., is fully or partially closed during the braking operation. The associated function is preferably stored in a control device.

According to a first specific example embodiment of the present invention, the hillhold function is configured in such a way that the pressure increase at at least one test wheel is prevented completely, and the associated wheel brake is kept nonpressurized when the driver is braking. This allows the test wheel to move should the vehicle be sliding. To limit the braking pressure, an intake valve of the wheel brake, for example, which is installed in most brake systems as it is, may be closed. In this first example embodiment, there is thus no need to operate the pump in order to reduce the braking pressure at the test wheel.

According to a second specific example embodiment of the present invention, the hillhold function is realized in such a way that the pressure increase at at least one test wheel is restricted and then reduced again. This has the advantage that the pump has to be operated only briefly due to the relatively low braking pressure at the test wheel.

The pressure reduction at the test wheel preferably takes place even before the vehicle has come to a standstill. The pump noise is less annoying to the driver in this case since the pump is operated before the vehicle has come to a standstill and the pump noise is therefore at least partially covered by other driving noise.

A third specific example embodiment of the present invention relates to a driving situation in which the driver actuates the brake pedal only quite lightly and the braking pressure is correspondingly low. In this case the wheel-braking pressure is not restricted during a braking operation. Instead, the level of the wheel-brake pressure is measured. If the braking pressure is less than a specified threshold value, then a discharge valve is opened at the wheel brake of the test wheel, and the braking pressure is thereby discharged into a reservoir. In this case the pressure reduction takes place without activation of the pump. To empty the reservoir, the pump is preferably operated only when the vehicle has begun to move again. The operating noise of the pump is then covered by other driving noise again and thus is no longer quite as disruptive.

The braking pressure at the test wheel is preferably restricted only in a driving situation in which the vehicle is decelerated from a low speed. This ensures that the vehicle reaches a prescribed minimum deceleration even at a restricted braking pressure, so that the driving safety is not at risk.

Furthermore, the afore-described methods are preferably implemented only under driving conditions in which there is a basic risk of sliding. According to the present invention, a sliding risk is assumed, for instance, when the outside temperature underhoots a specified temperature threshold value, e.g., 3° C.

The “sliding risk” state could optionally be determined by estimating coefficient of friction μ. Various conventional algorithms are available for this purpose. In this case the braking pressure is restricted only if the coefficient of friction is low and undershoots a specified threshold value. Other criteria may optionally be utilized as well.

The sliding test according to example embodiments of the present invention (i.e., the monitoring of the angular motion of a wheel) is preferably implemented on a wheel of the rear axle since they usually contribute a lower portion of the overall deceleration.

A brake system having hillhold function configured according to the present invention preferably includes a control device in which the HHC function is stored as algorithm, as well as a hydraulic brake system having a plurality of wheel brakes, at least one hydraulic pump, and a pressure-limiting device such as a valve, for example. The control device is connected at least to the pressure-limiting device and the hydraulic pump, and it controls them in the afore-described manner in the event of a braking operation in which the hillhold function is to be activated.

### BRIEF DESCRIPTION OF THE DRAWINGS

Below, the present invention is explained in greater detail by way of example, with reference to the attached figures.

FIG. 1 shows a schematic illustration of a hydraulic motor vehicle braking system having hillhold function.

FIG. 2 shows a flow chart to illustrate the main method steps of the hillhold function according to a first specific example embodiment of the present invention.

FIG. 3 shows a flow chart to illustrate the main method steps of the hillhold function according to a second specific example embodiment of the present invention.

FIG. 4 shows a flow chart to illustrate the main method steps of the hillhold function according to a third specific example embodiment of the present invention.

FIG. 5 shows a flow chart to illustrate the main method steps of the hillhold function according to a fourth specific example embodiment of the present invention.

### DETAILED DESCRIPTION OF EXAMPLE EMBODIMENTS

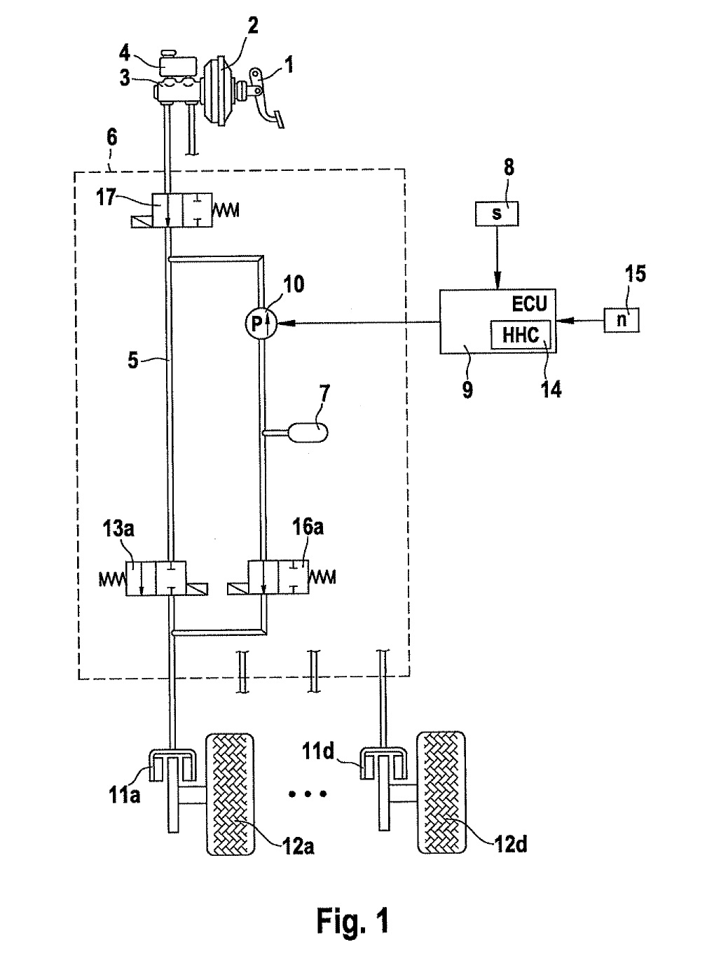

FIG. 1 shows a schematic illustration of a hydraulic braking system having hillhold function 14. In this case the actual brake system is depicted only schematically in the form of a block 6 for reasons of clarity.

The brake system includes a foot brake pedal 1 and a brake booster 2, which amplifies the brake force exerted by the driver, as well as a main brake cylinder 3 having a brake fluid reservoir 4 mounted thereon. If the brake is actuated, the braking pressure generated in main brake cylinder 3 is transmitted to the individual wheel brakes 11a-11d via a hydraulic line 5. This decelerates wheels 12a-12d of the vehicle.

The brake system includes a brake control device 9, in which a hillhold function (HHC) 14 is stored in addition to other algorithms. Hillhold function 14 is provided to safeguard the vehicle against unintentional rolling after a deceleration down to standstill. The function generally operates in the following manner: In a braking operation in which pressure is generated at wheel brakes 11a-11d, this pressure is locked in and maintained by closing valves 13a-13d and 16a-16d. (Only valves 13a and 16a of one of brakes 11 is shown of valves 13 and 16). The vehicle is thereby stopped automatically without the driver being required to actuate the foot brake pedal for this purpose. The function is deactivated again when the driver actuates the driving pedal or deactivates the function in some other manner, e.g., with the aid of a release switch.

In order to enable a rapid deactivation of HHC function 14 in a critical situation, the system implements a sliding test in which the movement of a test wheel (such as 12a) is monitored. If the state “vehicle is sliding” is detected in this test, then the HHC function is automatically deactivated, and the brake pressure locked in at brakes 11a through 11d is reduced again in order to ensure the steerability of the vehicle.

Below, different example methods of a hillhold function with associated sliding test are explained in greater detail by way of example.

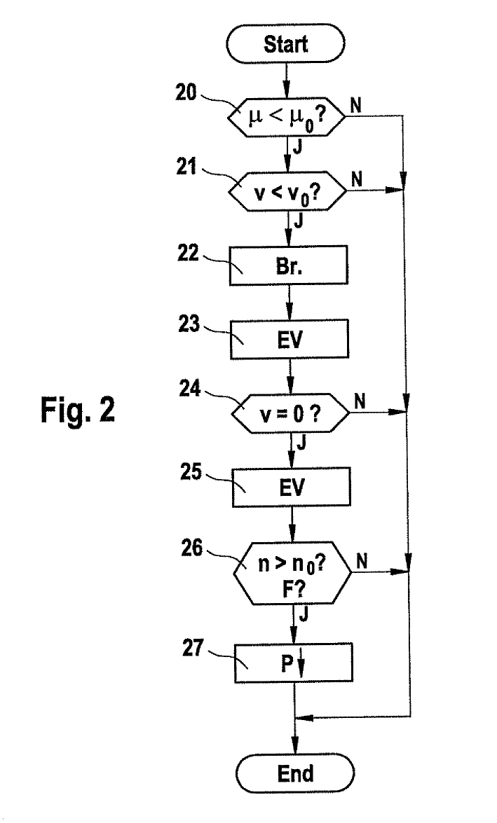

FIG. 2 shows a flow chart of a first example embodiment of a hillhold function having a sliding test. In this context, the generation of braking pressure during a braking operation is completely blocked at a selected wheel (test wheel) and enabled in the usual manner at the other wheels (e.g., 12b-12d). After the vehicle has come to a standstill, the test wheel (e.g., 12a) is therefore still able to rotate, while the other wheels (12b-12d) are blocked. If the test wheel begins to rotate at standstill, then the state “vehicle is sliding” is detected.

In detail, the function initially checks in step 20 whether driving conditions (such as an icy roadway) under which the vehicle may slide are present to begin with. The sliding danger may be detected by, for example, monitoring the ambient temperature or estimating coefficient of friction μ of the roadway. The sliding test is executed only if there actually is (J) a sliding risk. Otherwise (N), the method ends.

In step 21, it is checked whether velocity v of the vehicle is less than a specified lower velocity threshold v₀. For safety-related reasons, the pressure generation at a wheel brake may be blocked only at low vehicle velocities. At higher velocities (case N), there would otherwise be the risk that the vehicle deceleration desired by the driver is not attained. In this case (N), the method also ends. Vehicle velocity v may be determined from, for example, a signal of rpm sensors 15 (cf. FIG. 1).

If control device 9 detects in step 22 that the driver is actuating the foot brake pedal, then it triggers intake valve 13 of one of the rear wheels, e.g., 12c, in step 23, closes it and thereby blocks the pressure generation at the associated wheel brake (11c).

In next step 24, it is checked whether the vehicle has come to a standstill. This may likewise be detected by evaluating wheel-rpm sensors 15. However, if the driver actuates the driving pedal anew, then the method ends. As soon as the vehicle is at standstill, control device 9 triggers the valves (13a, b, d) of the other wheels (12a, 12b, 12d) in step 25 and blocks the braking pressure at the associated wheel brakes (11a, 11b, 11d). The other wheels are thus blocked.

The following method steps 26 and 27 describe a sliding test in which the movement of test wheel 12c is initially monitored in step 26. To this end, associated rpm sensor 15 is preferably evaluated. If the movement of test wheel 12c exceeds a specified threshold value n₀ (case J in step 26), then the state “vehicle is sliding” is detected, and the braking pressure is discharged directly from wheel brakes 11a, 11b, 11d in step 27. To this end, control device 9 triggers associated discharge valves 16a, 16b, 16d accordingly. The HHC is thereby automatically deactivated. An operation of hydraulic pump 10 for implementing the sliding test is not required in this case.

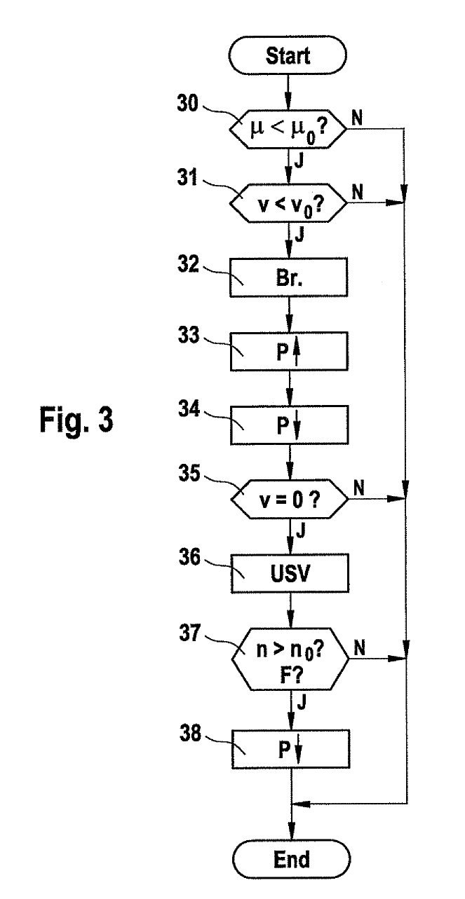

FIG. 3 shows a different specific example embodiment of a hillhold function having integrated sliding test, in which the generation of braking pressure at a test wheel (e.g., 12c) is allowed in a first phase of a braking operation, and the braking pressure is reduced again in a second phase of the braking operation, even before the vehicle is at a standstill.

In this example method, the basic sliding risk is initially evaluated again in step 30 and the velocity of the vehicle monitored in step 31, as described above with regard to method steps 20 and 21. In the event of braking (block 32), the generation of braking pressure at test wheel 12c is temporarily allowed (step 33). In step 34, braking pressure p is then reduced again at the wheel brake (11c) of the test wheel (12c) with the aid of hydraulic pump 10. In the process, pump 10 is controlled in such a way that it starts up at least prior to the standstill of the vehicle and preferably has reduced braking pressure p even before the vehicle has reached standstill. The running noise of the pump is thus at least partially covered by the other driving noises.

In step 35, the standstill of the vehicle is detected and the braking pressure then (step 36) once again locked in at the other wheel brakes 11a, 11b, 11d in order to safeguard the vehicle. In steps 37 and 38, the sliding test is then carried out and HHC function 14 is deactivated, if appropriate, as explained above in connection with steps 26 and 27.

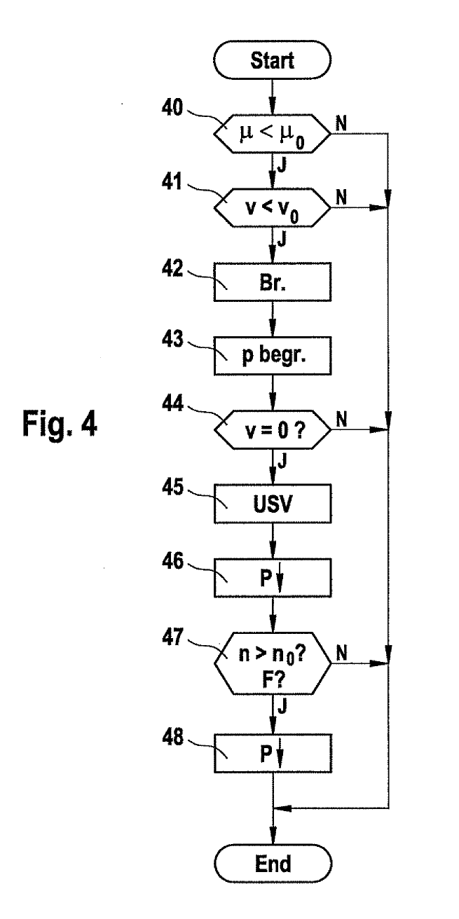

FIG. 4 shows the main method steps of a hillhold function having integrated sliding test, in which the generation of braking pressure at the test wheel (e.g., 12c) is restricted during the braking operation. In this way the running time of the pump for reducing the braking pressure is able to be shortened considerably. In contrast to the hillhold function of FIG. 3, the generation of braking pressure p at the test wheel (12c) is restricted here in step 44 by appropriate control of a pressure-limiting device (e.g., 13c). In this case the reduction of the braking pressure (step 35) at test wheel 12c may take place prior to or following the standstill of the vehicle (step 34).

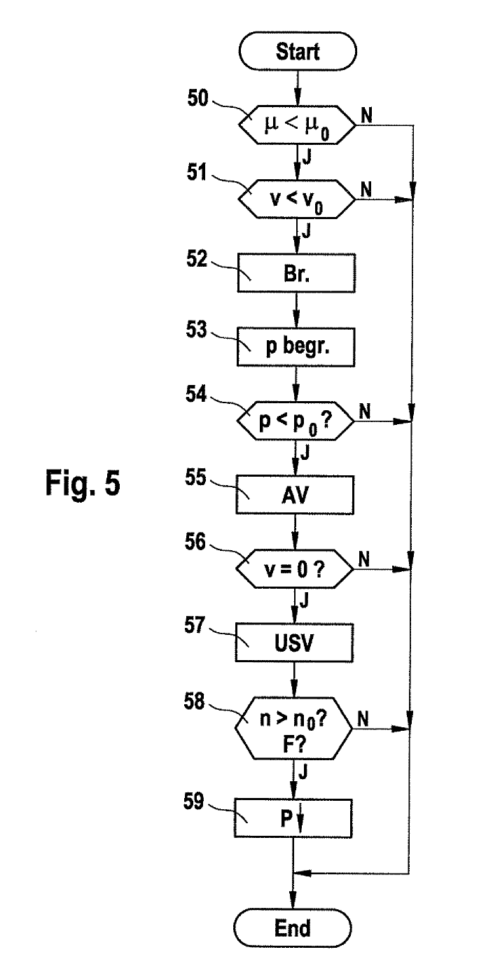

FIG. 5 shows a fourth specific example embodiment of a hillhold function having sliding test, in which the braking pressure at the test wheel is reduced without the use of pump 10, i.e., solely by opening a discharge valve 16 (cf. FIG. 1). The brake fluid flows through a reservoir 7 disposed downstream from wheel brake 11a-11d. During standstill of the vehicle it is therefore not necessary to operate pump 10. However, this method is possible only if the driver brakes only lightly and only relatively little brake fluid is therefore present in the wheel brakes.

In this example method the sliding danger is first evaluated again in step 50, and velocity v of the vehicle is monitored in step 51. In a braking operation, which is detected in step 52, the generation of braking pressure p at the test wheel, e.g., 12c, is restricted. The magnitude of braking pressure p in checked in step 54. If braking pressure p is greater than a specified threshold value p₀ (case N), the method ends. If pressure p is less, however, then pressure p at the test wheel (11c) is reduced in step 55 and transmitted into a reservoir 7. Since only relatively little brake fluid was in the brake (11c), braking pressure p will thereby be reduced to such an extent that the wheel is able to rotate freely and, in particular, no longer blocks. Following the vehicle standstill, which is detected in step 56, the pressure is locked in again at brakes 11a, 11b, 11d of the remaining wheels 12a, 12b, 12d. Once the deactivation condition has occurred in step 58, the braking pressure at wheels 12a, 12b, 12d is reduced again (step 59). If the vehicle has reached a specified velocity since driving off, pump 10 is finally activated in step 60 in order to empty reservoir 7. In this case, as well, the pump is not operated during the time when the vehicle is at standstill.

1-11. (canceled)

12. A method for securing a stationary vehicle against unintended rolling, comprising:
automatically locking in and maintaining a braking pressure prevailing at wheel brakes to secure the vehicle against unintended rolling during standstill; and
restricting a generation of braking pressure during a braking operation at a wheel brake of a test wheel so that a lower braking pressure than at other wheel brakes exists at the wheel brake of the test wheel.

13. The method as recited in claim 12, wherein the generation of braking pressure during a braking operation is completely prevented at the wheel brake of the test wheel, and the wheel brake of the test wheel is kept nonpressurized.

14. The method as recited in claim 12, wherein the lower braking pressure at the wheel brake of the test wheel is reduced again even prior to standstill of the vehicle to enable a movement of the test wheel in the event that the vehicle is sliding.

15. A method for securing a stationary vehicle against unintended rolling, comprising:
automatically locking in and maintaining a braking pressure prevailing at wheel brakes to secure the vehicle during standstill; and
determining a wheel braking pressure during a braking operation and, if the determined wheel braking pressure is lower than a specified threshold valve, opening a discharge valve of a test wheel to release braking pressure from a wheel brake of the test wheel.

16. The method as recited in claim 15, further comprising:
monitoring an ambient temperature and implement the method only if the ambient temperature is less than a specified threshold value.

17. The method as recited in claim 15, further comprising:
ascertaining a coefficient of friction of a roadway and implementing the method only if the coefficient of friction is smaller than a specified threshold value.

18. The method as recited in claim 15, wherein a valve of a brake system of the vehicle is triggered in order to restrict or prevent completely the generation of braking pressure at the wheel brake of the test wheel.

19. The method as recited in claim 15, further comprising:
monitoring a velocity of the vehicle during a braking operation, and restricting the generation of braking pressure at a wheel brake only if the velocity is smaller than a specified velocity threshold value.

20. The method as recited in claim 15, wherein the test wheel is a rear wheel.

21. The method as recited in claim 15, further comprising:
monitoring an angular motion of the test wheel and reducing the braking pressure at all wheels if a wheel speed of the test wheel is greater than a specified threshold value.

22. A control device for implementing a braking function by which a vehicle is able to be secured at standstill, the control device adapted to automatically lock-in and maintain a braking pressure prevailing at wheel brakes to secure the vehicle against unintended rolling during standstill, the control device further adapted to restrict generation of braking pressure during a braking operation at a wheel brake of test wheel so that a lower braking pressure that at other wheel brakes exists at the wheel brake of the test wheel.
